(19) United States
(12) Patent Application Publication
(10) Pub. No.: US 2020/0026829 A1
(43) Pub. Date: Jan. 23, 2020

(54) BIOMETRIC ACCESS CONTROL IDENTIFICATION CARD

(71) Applicant: Sensormatic Electronics, LLC, Boca Raton, FL (US)

(72) Inventor: Alexis Brooke Ehrlich, Boca Raton, FL (US)

(21) Appl. No.: 16/037,492

(22) Filed: Jul. 17, 2018

(51) Int. Cl. G06F 21/32; G07C 9/00

(52) U.S. Cl. CPC G06F 21/32; G06F 21/35; G07C 9/00158; G07C 9/00087

(57) ABSTRACT

An access control apparatus includes a sensor that detects biometric data regarding a user and an authentication circuit coupled to the sensor. The authentication circuit stores predetermined biometric data corresponding to the user and credential data corresponding to the user. The authentication circuit compares the detected biometric data to the predetermined biometric data and outputs the credential data based on the comparison indicating that the detected biometric data matches the predetermined biometric data.

### BACKGROUND

Access control restricts entrance to a property, building, facility, room, zone, or other physical location to authorized persons. Access control can be achieved by restricting entrance through a variety of access control points such as doors, turnstiles, parking gates, elevators, or other physical barriers where granting access can be electronically controlled.

### SUMMARY

One implementation of the present disclosure is an access control apparatus. The access control apparatus includes a sensor that detects biometric data regarding a user and an authentication circuit coupled to the sensor. The authentication circuit stores predetermined biometric data corresponding to the user and credential data corresponding to the user. The authentication circuit compares the detected biometric data to the predetermined biometric data and outputs the credential data based on the comparison indicating that the detected biometric data matches the predetermined biometric data.

Another implementation of the present disclosure is a method. The method includes detecting, by a sensor, biometric data regarding a user. The method includes comparing, by an authentication circuit coupled to the sensor, the detected biometric data to predetermined biometric data regarding the user stored by the authentication circuit. The method includes outputting, by the authentication circuit for receipt by an access controller, credential data corresponding to the user based on the comparison indicating that the detected biometric data matches the predetermined biometric data.

Another implementation of the present disclosure is an access control system. The access control system includes an access control apparatus and an access control. The access control apparatus includes a sensor that detects biometric data regarding a user and an authentication circuit coupled to the sensor. The authentication circuit stores credential data corresponding to the user. The authentication circuit transmits an authentication signal including the biometric data and the credential data responsive to receiving a request signal from the access controller. The access controller includes a communications circuit that transmits the request signal to the access control apparatus to request the credential data from the access control apparatus and a control circuit. The control circuit receives the authentication signal from the access control device, extracts the biometric data from the authentication signal, extracts the credential data from the authentication signal, compares the biometric data to predetermined biometric data corresponding to the user, compares the credential data to predetermined credential data corresponding to the user, and outputs an access command responsive to the biometric data matching the predetermined biometric data and the credential data matching the predetermined credential data.

Another implementation of the present disclosure is a method. The method includes detecting, by a sensor, biometric data regarding a user. The method includes outputting, by an authentication circuit, an authentication signal including the credential data and the biometric data. The method includes receiving, by an access controller, the authentication signal. The method includes determining, by the access controller, if the credential data matches the predetermined credential data and if the biometric data matches the predetermined biometric data. The method includes outputting, responsive to determining the biometric data to match the predetermined biometric data and the credential data to match the predetermined credential data, an access command.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a block diagram of an access control system that can be used for biometric access control, according to an embodiment of the present disclosure.

FIG. 2 is a block diagram of an access control system operating with a biometric access control identification card, according to an embodiment of the present disclosure.

FIG. 3 is a block diagram of another access control system operating with a biometric access control identification card, according to an embodiment of the present disclosure.

FIG. 4 is a flow diagram of a method of operating an access control system using a biometric access control identification card, according to an embodiment of the present disclosure.

FIG. 5 is a flow diagram of another method of operating an access control system using a biometric access control identification card, according to an embodiment of the present disclosure.

### DETAILED DESCRIPTION

### Overview

The present disclosure relates generally to the field of access control systems, and more particularly to systems and methods using a biometric access control identification card (“BACIC”). Referring generally to the figures, the BACIC can be used to enable multi-level authentication in a single apparatus carried by a user. In some embodiments, the BACIC includes a sensor that detects biometric data regarding a user and an authentication circuit coupled to the sensor. The authentication circuit stores predetermined biometric data corresponding to the user and credential data corresponding to the user. The authentication circuit compares the detected biometric data to the predetermined biometric data and outputs the credential data based on the comparison indicating that the detected biometric data matches the predetermined biometric data. In some embodiments, the BACIC detects the biometric data and outputs both the biometric data and the credential data.

An access control system can receive data from the BACIC (e.g., credential data; biometric data and credential data) and validate access to a user based on the received data. In some embodiments, the access control system includes one or more access control points. Each access control point can include a physical control panel, one or more readers, and one or more access control devices. The physical control panel can be connected to the readers and the access control devices via a hardwired serial connection. The readers can include proximity card readers, biometric readers, keypads, or other input device configured to receive a credential from a user (e.g., by reading an access badge, receiving a PIN, scanning a fingerprint, etc.). The access control devices can include electronic locks, actuators, or other controllable devices that can be operated to automatically grant or deny access through the access control points. For example, a door access control point can include an electronic lock configured to lock and unlock the door in response to a control signal from the physical control panel.

In some embodiments, the physical control panel can receive the credential data (outputted by the BACIC) from the reader and send the credential data to a central access control host (e.g., an access control server). The access control host can determine whether to grant or deny access by comparing the credential to an access control list. The access control host can send a result of the determination (e.g., grant or deny access) to the physical control panel, which operates the access control devices accordingly. For example, the physical control panel can unlock an electronic lock in response to receiving a control signal from the access control host.

By implementing a biometric sensor, the BACIC can improve operation of the access control system by enabling multi-level authentication (e.g., authentication based on biometric data and based on credential data) while reducing the electronic complexity required to achieve two-factor authentication. For example, existing multi-level authentication systems may use an identification card and a PIN code, or a separate card reader and biometric data reader. The security provided by such systems can be compromised due to issues such as lost, stolen, or duplicated identification cards; compromised PIN code entry; forgotten or incorrected entered PIN codes; or user interface error. In addition, existing systems may require complex, specialized biometric hardware at the access point to allow the system to detect and evaluate biometric data for a large number of users. In some embodiments, the present solution can obviate the need for a user to remember and accurately enter a PIN code at the access point; obviate the compromised security caused by lost, stolen, or duplicated identification cards; reduce the time required for each user to access an entry point; and enable multi-level authentication without requiring complex, specialized biometric hardware at the access point. In some embodiments, by implementing the biometric sensor in the BACIC itself (rather than at the access point), the present solution can enable multi-level authentication without requiring significant changes to existing single-level authentication points.

### Access Control Systems

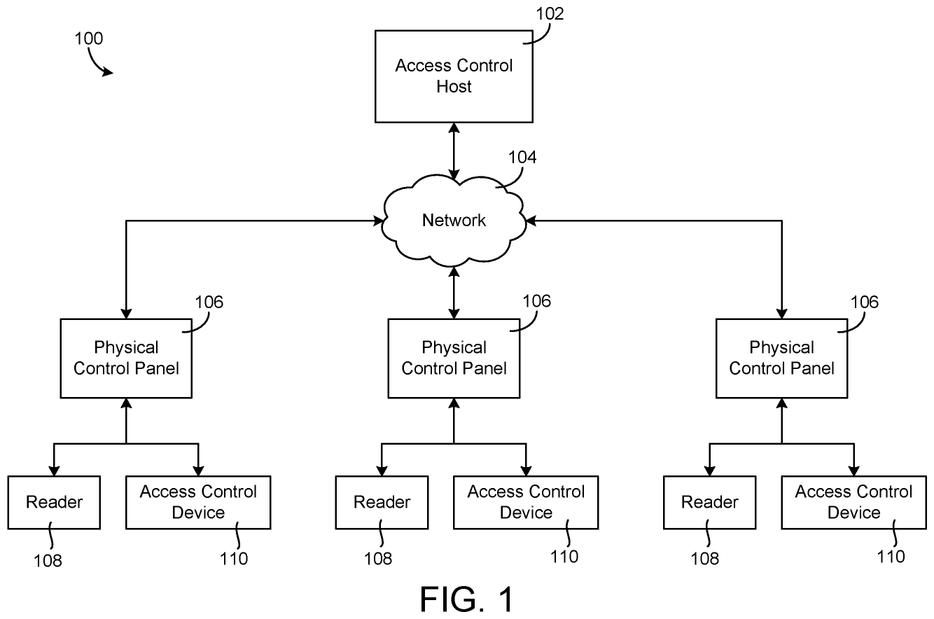

Referring now to FIG. 1, an access control system 100 is depicted. Access control system 100 monitors and controls access to various locations in or around a building (e.g., rooms or zones in a building, parking structures, etc.) using a collection of access control points. Each access control point is shown to include a physical control panel 106, a reader 108, and an access control device 110. Physical control panels 106 can be connected to readers 108 and access control devices 110 via a hardwired serial connection (e.g., RS-485 serial communication lines).

Readers 108 can receive credential data from a user via an access control card of a user. For example, readers 108 can read a smartcard (e.g., in integrated circuit card) possessed by a user to automatically obtain a smartcard ID from the smart card.

Access control devices 110 can include electronic locks, actuators, or other controllable devices that can be operated to automatically grant or deny access through the access control points. For example, a door access control point can include an electronic lock configured to lock and unlock the door in response to a control signal from the physical control panel. In some embodiments, access control devices 110 are distributed throughout a building or campus (i.e., a group of buildings). Each access control device 110 can be configured to control a particular access point (e.g., a doorway, a parking structure, a building entrance or exit, etc.).

User interactions with readers 108 (i.e., access requests) can be recorded as events and sent to access control host 102 via a communications network 104 (e.g., a TCP/IP network, a building automation and control network, a LAN, a WAN, etc.). Each event may include, for example, a timestamp, a device ID identifying the access control device 110, a security credential provided by the user at the access point (e.g., a smartcard ID, an access code, etc.), a user ID, and/or any other information describing the access request. Access control host 102 can process the events and determine whether to allow or deny the access request. In some embodiments, access control host 102 accesses a security database to determine whether the security credential provided by the user matches a stored security credential. In some embodiments, access control host 102 determines whether the user associated with the access request (e.g., defined by the user ID or smartcard ID) is authorized to access the area controlled by the access control device 110. In some embodiments, access control host 102 displays an alarm or prompt for a security workstation (e.g., a computer operated by security personnel) to allow or deny the access request.

### Access Control Systems Using a Biometric Access Control Identification Card

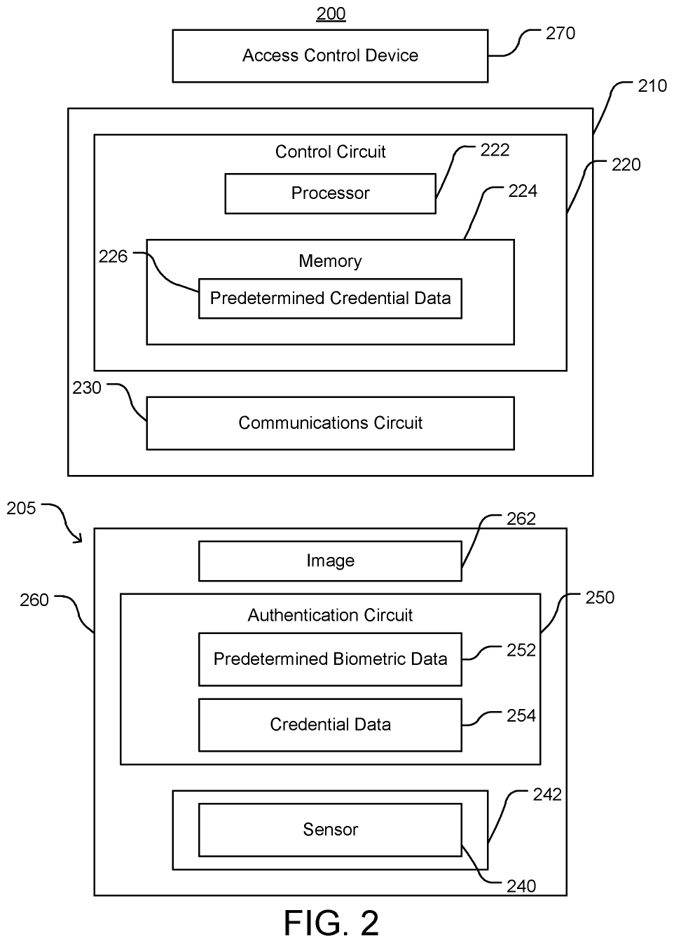

Referring now to FIG. 2, an access control system 200 operating with a biometric access control identification card (“BACIC”) 205 is depicted. The access control system 200 can incorporate features of the access control system 100 described with reference to FIG. 1.

The access control system 200 includes an access controller 210, which can incorporate features of the access control host 102, physical control panel 106, and reader 108 described with reference to FIG. 1. The access controller 210 includes a control circuit 220 and a communications circuit 230. The control circuit 220 is shown to include a processor 222 and memory 224. Processor 222 can be a general purpose or specific purpose processor, an application specific integrated circuit (ASIC), one or more field programmable gate arrays (FPGAs), a group of processing components, or other suitable processing components. Processor 222 is configured to execute computer code or instructions stored in memory 224 or received from other computer readable media (e.g., CDROM, network storage, a remote server, etc.).

Memory 224 can include one or more devices (e.g., memory units, memory devices, storage devices, etc.) for storing data and/or computer code for completing and/or facilitating the various processes described in the present disclosure. Memory 224 can include random access memory (RAM), read-only memory (ROM), hard drive storage, temporary storage, non-volatile memory, flash memory, optical memory, or any other suitable memory for storing software objects and/or computer instructions. Memory 224 can include database components, object code components, script components, or any other type of information structure for supporting the various activities and information structures described in the present disclosure. Memory 224 can be communicably connected to processor 222 via processing circuit 220 and may include computer code for executing (e.g., by processor 222) one or more processes described herein. When processor 222 executes instructions stored in memory 224, processor 222 generally configures the access controller 210 (and more particularly processing circuit 220) to complete such activities.

The communications circuit 230 can include wired or wireless interfaces (e.g., jacks, antennas, transmitters, receivers, transceivers, wire terminals, etc.) for conducting data communications with various systems, devices, or networks. For example, the communications circuit 230 can include an Ethernet card and port for sending and receiving data via an Ethernet-based communications network. As another example, the communications circuit 230 can include a WiFi transceiver for communicating via a wireless communications network. The communications circuit 230 can communicate via local area networks (e.g., a building LAN), wide area networks (e.g., the Internet, a cellular network, etc.), and/or conduct direct communications (e.g., NFC, Bluetooth, etc.). In various embodiments, the communications circuit 230 can conduct wired and/or wireless communications. For example, the communications circuit 230 can include one or more wireless transceivers (e.g., a Wi-Fi transceiver, a Bluetooth transceiver, a NFC transceiver, a cellular transceiver, etc.) for communicating with access control host 102 via communications network 104.

In some embodiments, the control circuit 220 generates a request signal to request credential data from the BACIC 205. The control circuit 220 can generate the request signal to cause the BACIC 205 to transmit credential data, and can cause the communications circuit 230 to transmit the request signal for reception by the BACIC 205. The communications circuit 230 can transmit the request signal as an electromagnetic signal. The communications circuit 230 can transmit the request signal to include a sufficient power level (e.g., within a threshold distance of the access controller 210 at which the BACIC 205 would be expected to be located when being used to request access) to cause authentication circuit 250 of BACIC 205 to be able to transmit an output signal. The control circuit 220 can control operation of one or more

The BACIC 205 includes a sensor 240 that detects biometric data regarding a user. The sensor 240 can include a biometric data chip that detects a finger of the user when the finger is in contact with the sensor 240. The sensor 240 can record sensor data regarding the finger of the user, such as shapes or other characteristics of the finger of the user.

The BACIC 205 includes an authentication circuit 250. The authentication circuit 250 stores predetermined biometric data 252 corresponding to the user. The predetermined biometric data 252 can include one or more templates representing characteristics of biometric data corresponding to the user, such as a template of a fingerprint of the user. The authentication circuit 250 stores credential data 254 corresponding to the user.

The authentication circuit 250 can compare the biometric data detected by the sensor 240 to the predetermined biometric data 252. For example, the authentication circuit 250 can extract one or more features of the detected biometric data, and compare the one or more features to the one or more templates of the predetermined biometric data 252. The authentication circuit 250 can calculate a match score based on the comparison (e.g., a percentage match confidence between zero percent (no match) and one hundred percent (certain match)). The authentication circuit 250 compare the match score to a threshold match score, and output an indication that the detected biometric data matches the predetermined biometric data based on the match score meeting (or exceeding) the threshold match score.

The authentication circuit 250 can output the credential data 254 based on the comparison indicating that the detected biometric data matches the predetermined biometric data 252. The authentication circuit 250 can output the crendetial data 254 for receipt by the access controller 210. In some embodiments, the authentication circuit prevents output of the credential data based on the detected biometric data not matching the predetermined biometric data 252. For example, the authentication circuit 250 can execute an output function which, in response to receiving the request signal from the control circuit 220, determines whether the detected biometric data matches the predetermined biometric data 252, responsive to determining the detected biometric data to match the predetermined biometric data 252, outputs the credential data 254, and responsive to the detected biometric data not matching the predetermined biometric data 252, outputs an error signal, terminates the output function, or otherwise does not output the credential data 254. The authentication circuit 250 can output the credential data 254 as an authentication signal for reception by the access controller 210. In some embodiments, the authentication circuit 250 does not transmit the authentication signal unless the sensor 240 is in a state of detecting the biometric data regarding the user (e.g., a finger of the user is in contact with the surface 242 of the sensor 240, and the sensor 240 outputs a signal indicating that the sensor 240 is currently detecting the biometric data regarding the user).

In some embodiments, the BACIC 205 includes a card housing 260 that supports the sensor 240 and the authentication circuit 250. The sensor 240 can be disposed in the card housing 260 such that a surface 242 of the sensor 240 is exposed, which can allow a user to contact the surface 242 (e.g., with a finger) and the sensor 240 to detect biometric data based on the contact from the user. For example, the sensor 240 can detect a fingerprint of the user while the finger of the user is in contact with the surface 242. In some embodiments, the card housing 260 includes an image 262 of the user.

The credential data 254 can be used by the access controller 210 to validate access into a space in a building. The control circuit 220 can store predetermined credential data 226 corresponding to the user. The control circuit 220 can extract the credential data from the authentication signal outputted by the authentication circuit 250 of the BACIC 205. The control circuit 220 can compare the credential data to the predetermined credential data 226. Based on the comparison indicating that the credential data matches the predetermined credential data 226, the control circuit 220 can output an access command to enable access. For example, the control circuit 220 can output the access command to an access control device 270 (e.g., a door, a lock, a turnstile) to cause the access control device 270 to open or otherwise allow access to the user.

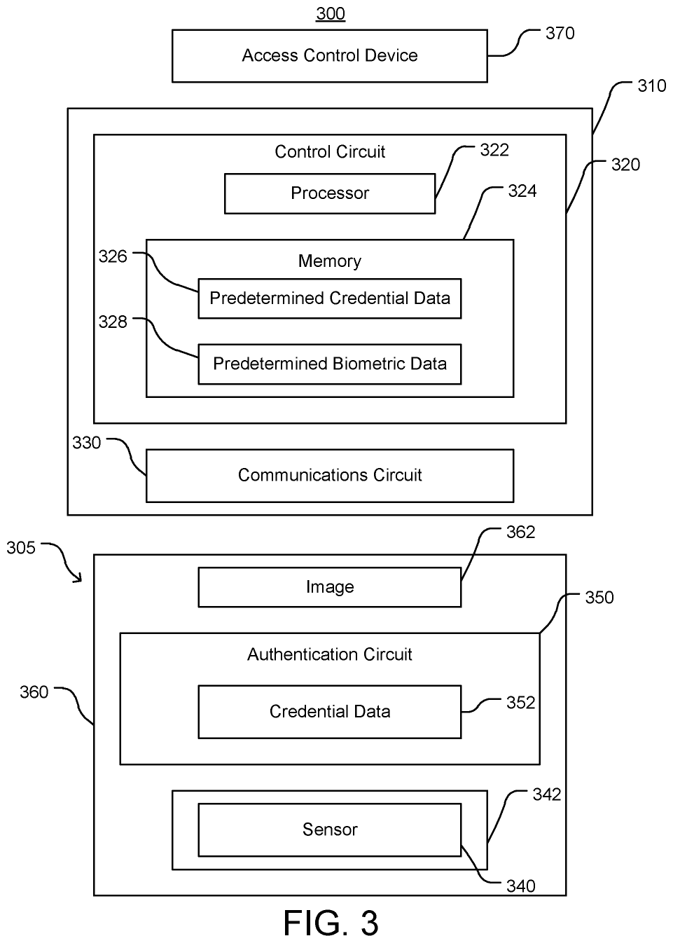

Referring now to FIG. 3, an access control system 300 operating with a biometric access control identification card (“BACIC”) 305 is depicted. The access control system 300 can incorporate features of the access control system 100 described with reference to FIG. 1. The access control system 300 is similar to the access control system 200 described with reference to FIG. 2, except that the BACIC 305 can provide both biometric data and credential data to an access controller. In some embodiments, the access control system 300 can operate in a first mode analogous to access control system 200 (e.g., where the BACIC 305 would selectively transmit credential data based on using an authentication circuit to evaluate biometric data) and a second mode as described below (e.g., where the BACIC 305 transmits both biometric data and credential data).

As depicted in FIG. 3, the access control system 300 includes the BACIC 305 and an access controller 310. Similar to the access controller 210, the access controller 310 includes a control circuit 320, including a processor 322 and memory 324, and a communications circuit 330. The control circuit 220 can generate a request signal to request credential data from the BACIC 305 and cause the communications circuit 330 to transmit the request signal.

The BACIC 305 includes a sensor 340, an authentication circuit 350, and a card housing 360. The BACIC 305 can include an image 362 of the user.

The sensor 340 detects biometric data regarding the user, such as when a finger of the user is detected to be in contact with a surface 342 of the sensor 340. The authentication circuit 350 includes credential data 352 corresponding to the user. In response to receiving the request signal from the access controller 310, the authentication circuit 350 can transmit an authentication signal including both the credential data and the biometric data to the access controller 310. In some embodiments, the authentication circuit 350 does not transmit the credential data and the biometric data unless the sensor 340 is in a state of detecting the biometric data regarding the user (e.g., a finger of the user is in contact with the surface 342 of the sensor 340, and the sensor 340 outputs a signal indicating that the sensor 340 is currently detecting the biometric data regarding the user).

The communications circuit 330 of the access controller 310 receives the authentication signal from the BACIC 305. The control circuit 320 can extract the credential data and the biometric data from the authentication signal. The control circuit 320 stores predetermined credential data 326 corresponding to the user, and stores predetermined biometric data 328 corresponding to the user. The control circuit 320 can compare the credential data extracted from the authentication signal to the predetermined credential data 326, and determine whether the credential data matches the predetermined credential data 326 based on the comparison. The control circuit 320 can compare the biometric data extracted from the authentication signal to the predetermined biometric data 328, and determine whether the biometric data matches the predetermined biometric data 328 based on the comparison.

Responsive to the credential data matching the predetermined credential data 326 and the biometric data matching the predetermined biometric data 328, the control circuit 320 can validate access. For example, the control circuit 320 can generate an access command, and transmit the access command to an access control device 370 (e.g., a door, a lock, a turnstile) to cause the access control device 370 to open or otherwise allow access to the user.

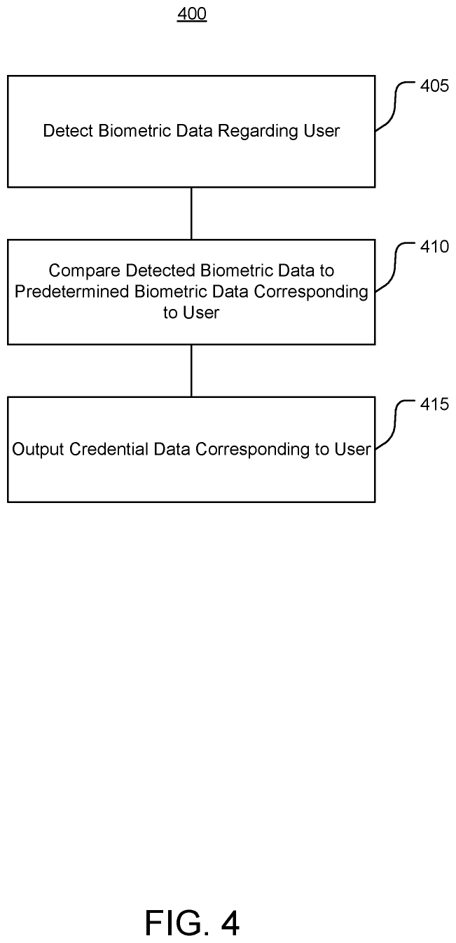

Referring now to FIG. 4, a method 400 of operating an access control system is depicted. The method 400 can be performed using the access control system 200.

At 405, a sensor detects biometric data regarding a user. The sensor can detect a presence of a user based on contact by the user (e.g., by a finger of the user) on a surface of the sensor. The sensor can be provided in a card housing that supports the sensor. The sensor can detect a fingerprint of the user to be the biometric data.

At 410, an authentication circuit compares the detected biometric data to predetermined biometric data regarding the user that is stored by the authentication circuit. The authentication circuit can be provided in the card housing, and coupled to the sensor to receive the biometric data from the sensor. The authentication circuit can extract one or more features of the detected biometric data, and compare the extracted features to the predetermined biometric data, to determine if the detected biometric data matches the predetermined biometric data.

At 415, the authentication circuit outputs, for receipt by an access controller, credential data corresponding to the user based on the comparison indicating that the detected biometric data matches the predetermined biometric data. The authentication circuit stores the credential data. The authentication circuit can output the credential data as an authentication signal that includes the credential data. The authentication circuit can output the authentication signal in response to receiving a request signal from an access controller. The authentication circuit can use power from the request signal to generate and transmit the authentication signal. The authentication circuit can prevent output of the credential data based on the detected biometric data not matching the predetermined biometric data.

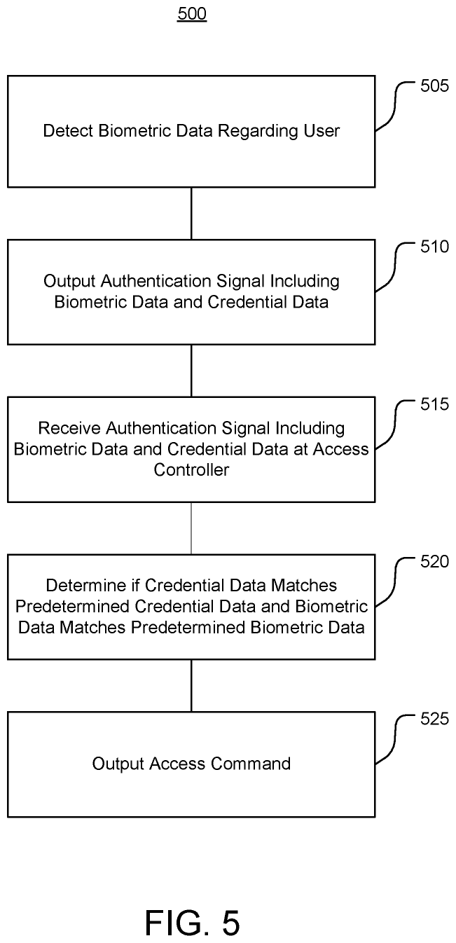

Referring now to FIG. 5, a method 500 of operating an access control system is depicted. The method 500 can be performed using the access control system 300.

At 505, a sensor detects biometric data regarding a user. The sensor can detect a presence of a user based on contact by the user (e.g., by a finger of the user) on a surface of the sensor. The sensor can be provided in a card housing that supports the sensor. The sensor can detect a fingerprint of the user to be the biometric data.

At 510, an authentication circuit outputs an authentication signal including the biometric data and the credential data. The authentication circuit can be provided in the card housing, and coupled to the sensor to receive the biometric data from the sensor. The authentication circuit can store the credential data. The authentication circuit can output the authentication signal responsive to receiving a request signal from an access controller. The request signal may be periodically transmitted by the access controller. The authentication circuit can use power from the request signal to transmit the authentication signal. In some embodiments, the authentication circuit does not output the authentication signal unless the sensor indicates that it is currently in a state of detecting the biometric data regarding the user.

At 515, the access controller receives the authentication signal. The access controller can extract the credential data and the biometric data from the authentication signal. The access controller stores predetermined credential data and predetermined biometric data corresponding to the user.

At 520, the access controller determines if the credential data matches the predetermined credential data and if the biometric data matches the predetermined biometric data. For example, the predetermined credential data and predetermined biometric data can include template features that the access controller compares the credential data and the biometric data to, respectively, to determine the match.

At 525, responsive to determining the biometric data to match the predetermined biometric data and the credential data to match the predetermined credential data, the access controller outputs an access command. The access command can cause an access control device (e.g., a door, a lock, a turnstile, a gate) to actuate, allowing access to the user.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An access control apparatus, comprising:
a sensor that detects biometric data regarding a user; and
an authentication circuit coupled to the sensor, the authentication circuit storing predetermined biometric data corresponding to the user and credential data corresponding to the user, the authentication circuit compares the detected biometric data to the predetermined biometric data and outputs the credential data based on the comparison indicating that the detected biometric data matches the predetermined biometric data.

2. The access control apparatus of claim 1, comprising:
the sensor detects a fingerprint of the user.

3. The access control apparatus of claim 1, comprising:
the authentication circuit prevents output of the credential data based on the detected biometric data not matching the predetermined biometric data.

4. The access control apparatus of claim 1, comprising:
a card housing that supports the sensor and the authentication circuit.

5. The access control apparatus of claim 1, comprising:
the authentication circuit does not output the credential unless the sensor detects a finger of the user in contact with the sensor.

6. The access control apparatus of claim 1, comprising:
the authentication circuit uses power from a request signal received from an access controller to transmit the credential data to the access controller.

7. A method, comprising:
detecting, by a sensor, biometric data regarding a user;
comparing, by an authentication circuit coupled to the sensor, the detected biometric data to predetermined biometric data regarding the user stored by the authentication circuit; and
outputting, by the authentication circuit for receipt by an access controller, credential data corresponding to the user based on the comparison indicating that the detected biometric data matches the predetermined biometric data.

8. The method of claim 7, comprising:
detecting, by the sensor, a fingerprint of the user.

9. The method of claim 7, comprising:
preventing, by the authentication circuit, output of the credential data based on the detected biometric data not matching the predetermined biometric data.

10. The method of claim 7, comprising:
transmitting, by the authentication circuit, the credential data to an access controller using power from a request signal received from the access controller.

11. An access control apparatus, comprising:
a sensor that detects biometric data regarding a user; and
an authentication circuit coupled to the sensor, the authentication circuit storing credential data corresponding to the user, the authentication circuit transmits the biometric data and the credential data to an access controller responsive to receiving a request signal from the access controller.

12. The access control apparatus of claim 11, comprising:
the sensor detects a fingerprint of the user.

13. The access control apparatus of claim 11, comprising:
a card housing that supports the sensor and the authentication circuit.

14. The access control apparatus of claim 11, comprising:
the authentication circuit does not output the credential unless the sensor detects a finger of the user in contact with the sensor.

15. The access control apparatus of claim 11, comprising:
the authentication circuit uses power from the request signal to transmit the credential data to the access controller.

16. An access control system, comprising:
an access control apparatus, comprising:
a sensor that detects biometric data regarding a user; and
an authentication circuit coupled to the sensor, the authenticating circuit storing credential data corresponding to the user, the authentication circuit transmits an authentication signal including the biometric data and the credential data responsive to receiving a request signal; and
an access controller, comprising:
a communications circuit that transmits the request signal to the access control apparatus to request the credential data from the access control apparatus; and
a control circuit that receives the authentication signal from the access control device, extracts the biometric data from the authentication signal, extracts the credential data from the authentication signal, compares the biometric data to predetermined biometric data corresponding to the user, compares the credential data to predetermined credential data corresponding to the user, and outputs an access command responsive to the biometric data matching the predetermined biometric data and the credential data matching the predetermined credential data.

17. The access control system of claim 16, comprising:
the access controller periodically transmits the request signal.

18. The access control system of claim 16, comprising:
the control circuit generates the access command to cause an access control device including at least one of a door, a lock, a turnstile, and a gate to actuate.

19. The access control system of claim 16, comprising:
the sensor detects a fingerprint of the user.

20. The access control system of claim 16, comprising:
the authentication circuit uses power from the request signal to transmit the authentication signal.
